(19) United States
(12) Patent Application Publication
(10) Pub. No.: US 2010/0095204 A1
(43) Pub. Date: Apr. 15, 2010

(54) INFORMATION PROCESSING APPARATUS, INFORMATION PROCESSING METHOD, AND STORAGE MEDIUM

(75) Inventor: Yuji Kobayashi, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/558,214

(22) Filed: Sep. 11, 2009

(30) Foreign Application Priority Data
Sep. 18, 2008 (JP) 2008-239442

(51) Int. Cl. G06F 17/30

(52) U.S. Cl. 715/700

(57) ABSTRACT

At least one layout data item is generated based on a layout pattern data item in which information about an area where at least one content data item is arranged is defined, and at least one new layout pattern data item is generated based on the layout pattern data item when the number of at least two different layout data items for generation is smaller than a predetermined number, so as to obtain at least two different layout pattern data items even though an operator does not specify a position where the content data item is arranged.

### BACKGROUND OF THE INVENTION

1. Field of the Invention

The present invention relates to an information processing apparatus performing layout processing.

2. Description of the Related Art

Layout editing application programs used to perform desktop publishing (DTP) or the like have been used in the past. The term “DTP” means that an operator lays out content data provided as a document material through a computer. According to a method that can be prepared through the above-described layout editing application programs, layout template data is prepared in advance, and material data is applied to the layout template data so that document data is generated. Further, there have been proposed systems in which content data provided as a material is not manually laid out by an operator, but is automatically arranged according to a computer program.

Japanese Patent Laid-Open No. 2000-158861 proposed an image layout apparatus which automatically generates layout data in which margins between images are rendered uniform by adding a margin area having a predetermined width along the outline of the image data of a material so that a given area is covered with the margin area. Further, Japanese Patent Laid-Open No. 11-250272 proposes an automatic image layout method in which a plurality of images are combined with each other and arranged based on a minimization algorithm so that the amount of the margin of page data is minimized.

Each of the apparatus disclosed in Japanese Patent Laid-Open No. 2000-158861 and the method disclosed in Japanese Patent Laid-Open No. 11-250272 allows for adjusting the margin area. However, since it has been difficult to automatically generate different combinations of layouts of content data items provided as document materials, it has been difficult for operators to obtain various layouts.

### SUMMARY OF THE INVENTION

Accordingly, the present invention allows for outputting at least two different layout pattern data items even though an operator does not specify a position where content data is arranged.

Therefore, according to an embodiment of the present invention, a layout unit configured to generate at least one layout data item based on a layout pattern data item in which information about an area where at least one content data item is arranged is defined, and a generation unit configured to generate at least one new layout pattern data item based on the layout pattern data item when a number of at least two different layout data items generated by the layout unit is smaller than a predetermined number are provided.

Further features of the present invention will become apparent from the following description of exemplary embodiments with reference to the attached drawings.

### BRIEF DESCRIPTION OF THE DRAWINGS

FIG. 1 shows an exemplary hardware configuration of an information processing apparatus (computer).

FIG. 2 shows an exemplary functional configuration of the information processing apparatus.

FIG. 3A shows an exemplary document template data item.

FIG. 3B shows another exemplary document template data item.

FIG. 4 shows exemplary layout pattern data items.

FIG. 5A shows an exemplary dynamic configuration including a layout pattern data item.

FIG. 5B shows exemplary dynamic configurations including combinations of layout pattern data items.

FIG. 5C shows exemplary dynamic configurations including combinations of layout pattern data items.

FIG. 5D shows exemplary dynamic configurations including combinations of layout pattern data items.

FIG. 6 shows exemplary management of layout pattern data items.

FIG. 7 shows exemplary content data items targeted to be automatically laid out.

FIG. 8 exemplarily shows how layout data items are generated by applying at least one content data item to layout pattern data.

FIG. 9 exemplarily shows how layout data items are generated by applying at least one content data item to layout pattern data.

FIG. 10 shows how layout data items are generated based on document template data.

FIG. 11 shows an exemplary on-demand automatic layout operation.

FIG. 12 is a flowchart showing exemplary on-demand automatic layout processing procedures.

FIG. 13 is a flowchart showing exemplary automatic layout generation processing procedures.

FIG. 14 is a flowchart showing exemplary layout pattern generation processing procedures.

FIG. 15 is a flowchart showing different exemplary layout pattern generation processing procedures.

FIG. 16 is a flowchart showing exemplary layout generation processing procedures.

FIG. 17 shows the configuration of layout pattern data.

FIG. 18 also shows the configuration of layout pattern data.

FIG. 19 also shows the configuration of layout pattern data.

FIG. 20 shows exemplary on-demand automatic layout operations.

FIG. 21 also shows exemplary on-demand automatic layout operations.

### DESCRIPTION OF THE EMBODIMENTS

Hereinafter, embodiments of the present invention will be described with reference to the attached drawings.

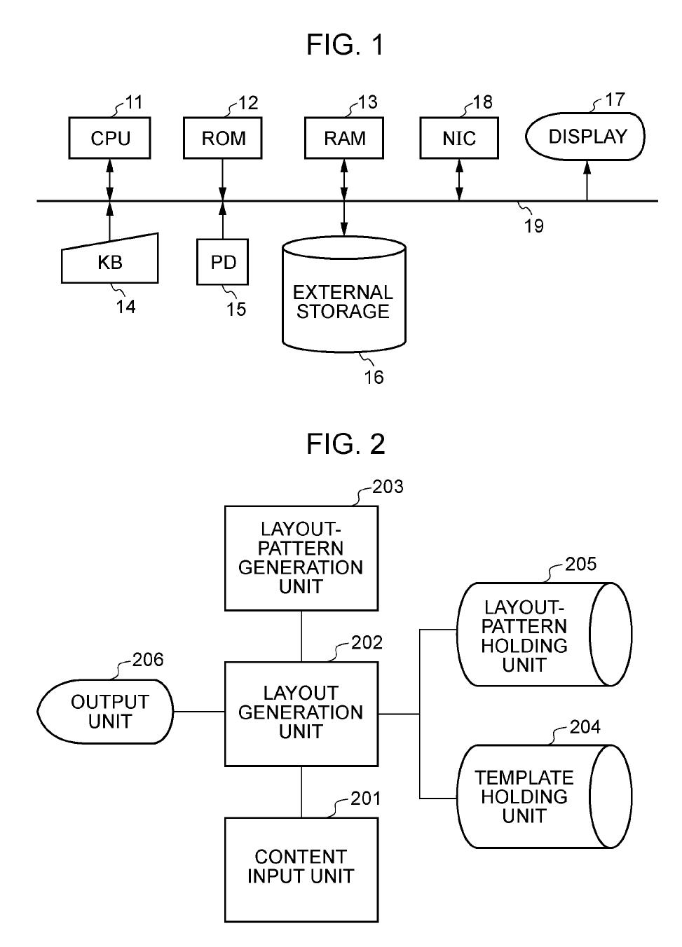

FIG. 1 shows an exemplary hardware configuration of an information processing apparatus (computer). In FIG. 1, a central processing unit (CPU) 11 executes various control processing procedures for the information processing apparatus. A read-only memory (ROM) 12 stores a boot program executed when the information processing apparatus is started and/or various data items. A random access memory (RAM) 13 stores a control program executed by the CPU 11, and presents a work area used by the CPU 11 executing the various control processings. Each of a keyboard (KB) 14 and a pointing device (PD) 15 is a human interface device presenting an environment in which a user performs various input operations. Namely, the KB 14 is a keyboard and the PD 15 is a pointing device including a mouse, a trackball, a touch panel, and so forth.

External storage 16 includes a hard disk, an optical disk, a magnetic disk, a magneto-optical disk, a magnetic tape, and so forth. However, if the control program and/or various data items are stored in the ROM 12, the external storage 16 is not necessarily provided. A display device 17 includes a display or the like and displays the processing result, for example. A network interface (NIC) 18 can communicate with different devices installed on a network via a local-area-network (LAN) cable or the like. A bus 19 connects the above-described components with one another.

The CPU 11 executes processing procedures based on a program stored in the ROM 12 and/or the external storage 16 so that functions of the information processing apparatus and/or processing procedures shown in flowcharts, which will be described later, are achieved.

FIG. 2 shows an exemplary functional configuration of the information processing apparatus.

A content input unit 201 specifies image information and/or text information provided as exemplary content data accumulated on the external storage 16, as a document material, and transmits data of the specified information to a layout generation unit 202. A template holding unit 204 stores document-layout-template information (hereinafter referred to as document template data) describing a page and/or a partial layout included in the page. A layout-pattern holding unit 205 stores basic-layout-pattern information (hereinafter referred to as layout pattern data) used to generate the partial layout by combining content data items with each other, where the content data items are specified for inputting by the content input unit 201. Further, the layout pattern generation unit 203 generates layout pattern data, which is not stored in the layout pattern holding unit 205 as appropriate, and adds the layout pattern data to the layout pattern holding unit 205.

The layout generation unit 202 refers to the layout pattern data stored in the layout pattern holding unit 205 and generates the partial layout based on the content data items specified for inputting by the content input unit 201. Further, the layout generation unit 202 executes page layout processing by referring to the document template data stored in the template holding unit 204, and generates document data that can be transmitted to an output unit 206.

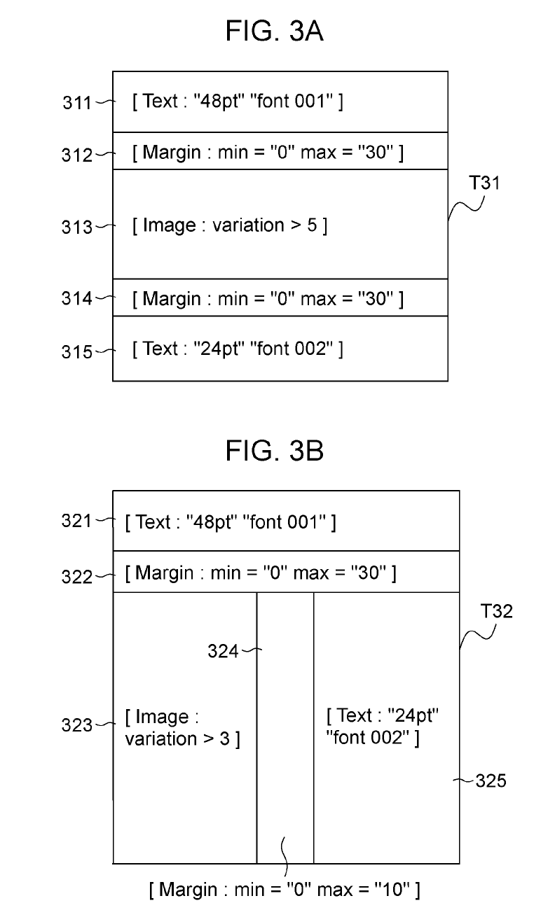

Each of FIGS. 3A and 3B shows exemplary document template data.

In a box T31 shown in FIG. 3A, each of sections 311 and 315 is a text frame in which text information is arranged. Each of the text frames 311 and 315 stores information about a predetermined character size and font information. Each of margin areas 312 and 314 stores information about a variable margin between content frames, where content data is stored in each of the content frames, and has information about the minimum value and the maximum value of the margin, as information about predetermined values. The predetermined values of the margin are in millimeters (mm). Information about an image including a photograph, an illustration, and so forth is arranged in an image frame 313. Layout pattern data including a combination of at least two image information items can be arranged in the image frame 313. Namely, information about the number of different recommended layout patterns is arranged in the image frame 313. A box T32 shown in FIG. 3B shows a document template having a layout different from that of the box T31, and includes text frames 321 and 325, margin areas 322 and 324, and an image frame 323, as is the case with the box T31.

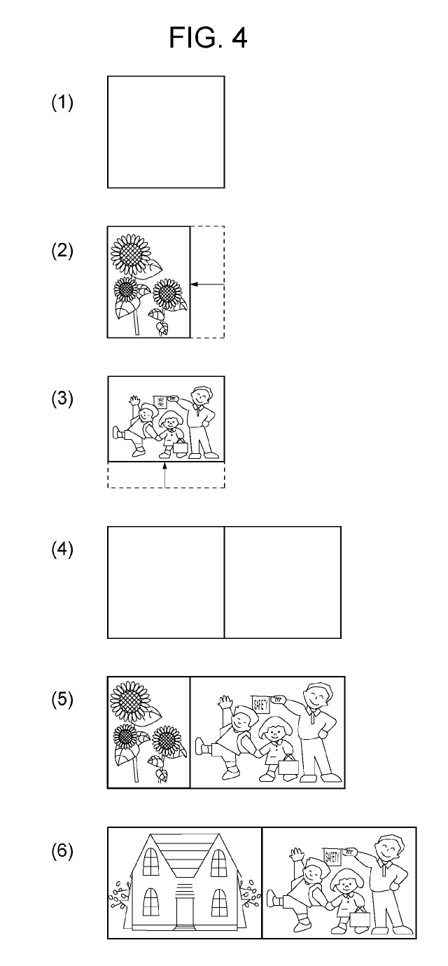

FIG. 4 shows exemplary layout patterns.

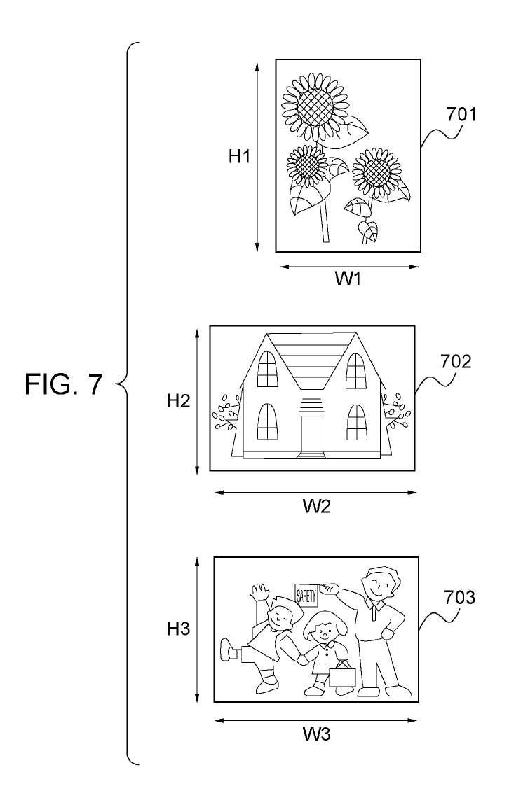

A layout pattern (1) shown in FIG. 4 is the most basic layout pattern defined based on a single arrangement area. The layout pattern (1) is expressed and held as information about a rectangle. The value of the aspect ratio of the rectangle is not fixed, and is determined based on the aspect-ratio shape of content data. A layout pattern (2) indicates an operation performed when image data 701 shown in a box 701 shown in FIG. 7 is applied to the layout pattern (1). The image data 701 has shape metrics of a height H1 and a width W1. The layout pattern (1) is used to determine the pattern shape so that the pattern shape becomes an aspect-ratio shape determined based on the height and the width of the image data 701. Similarly, a layout pattern (3) has a shape obtained when image data 703 shown in FIG. 7 is applied to the layout pattern (1). A layout pattern (4) includes a layout pattern including two arrangement areas. A layout pattern (5) shows a shape obtained when the image data 701 and the image data 703 are applied to the layout pattern 4. A layout pattern (6) shows a shape of a layout pattern obtained by applying image data 702 and the image data 703 that are shown in FIG. 7 to the above-described layout pattern (4). Thus, each of the above-described layout patterns is a structure including position information included in a rectangular area where the aspect ratio of content data is retained and no margin occurs.

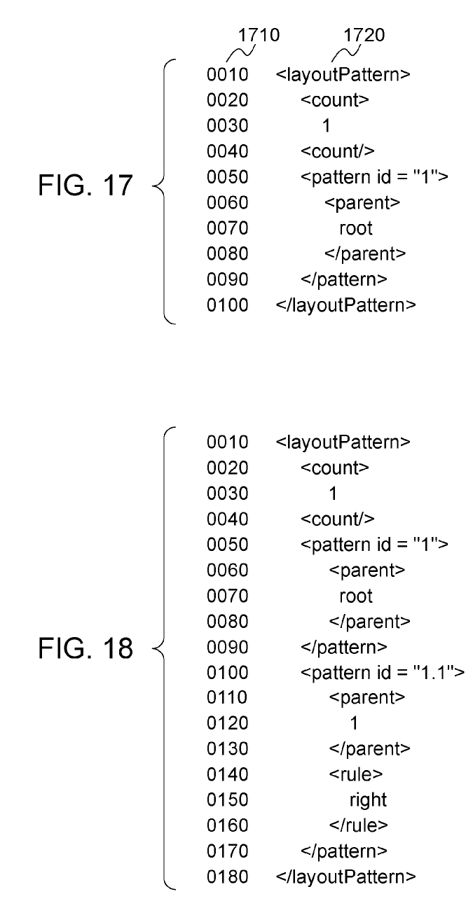

Each of FIGS. 17, 18, and 19 shows an exemplary configuration of the layout pattern.

The layout pattern is described in Extensible Markup Language (XML). In FIG. 17, reference number 1710 is a row number written for clarification. Reference number 1720 denotes layout pattern data according to the above-described embodiment.

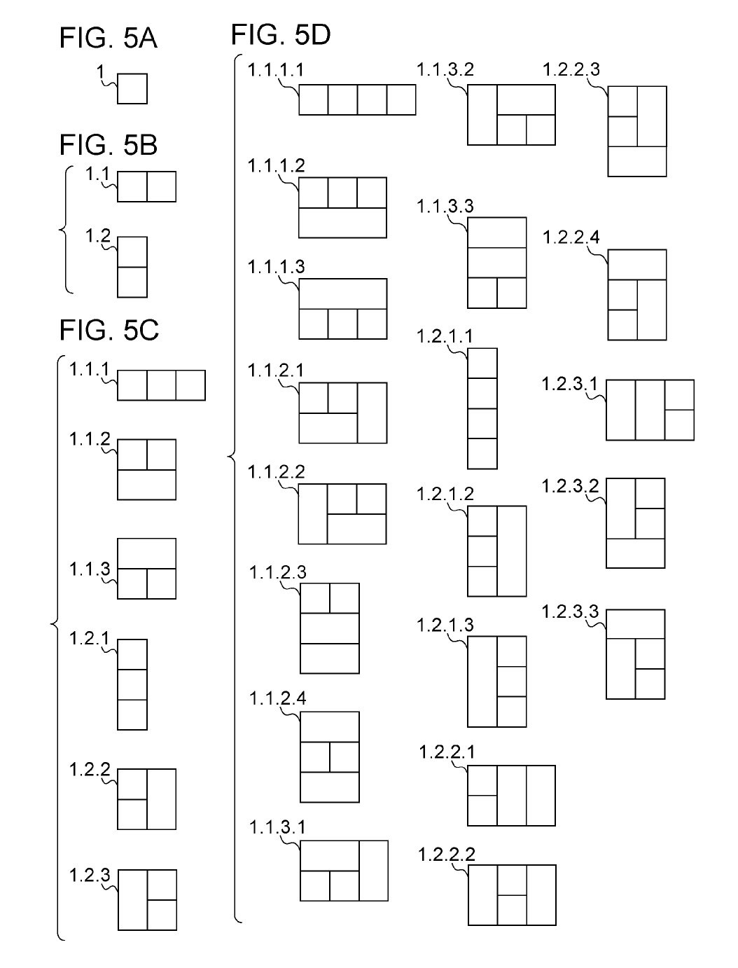

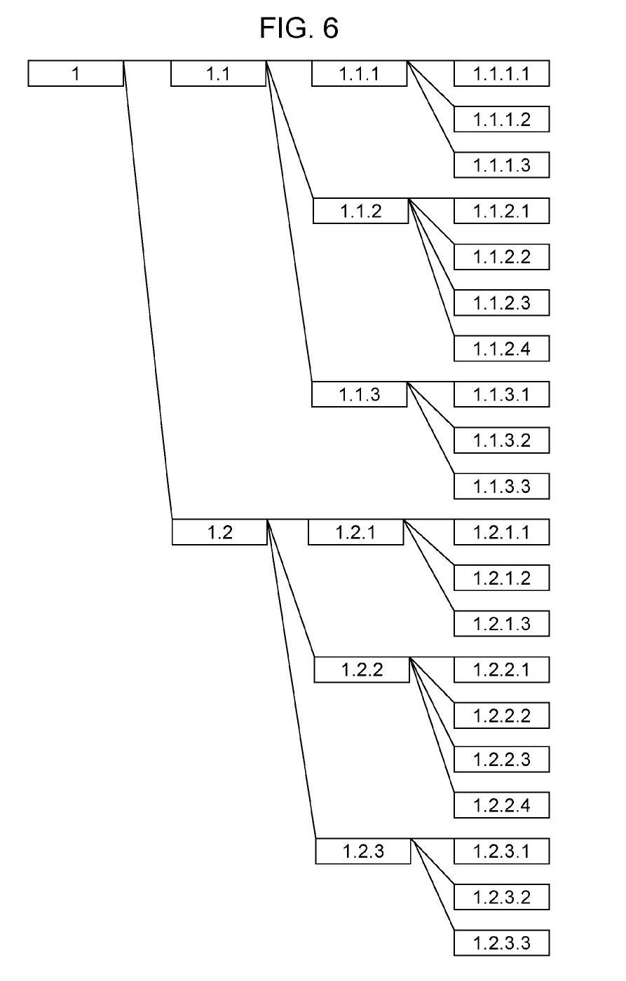

Data indicated by a row number 0010 shown in FIG. 17 is element data declaring the beginning of the layout pattern data, and data within data items indicated by a row number 0100 is effective layout pattern data. Element data “count” indicated by a row number 0020 denotes the number of stored layout pattern data items, and data indicated by a row number 0040 finishes a storage declaration. According to FIG. 17, a single layout pattern data item is stored, as indicated by a row number 0030. Element data “pattern” indicated by a row number 0060 is the main body of data indicating the structure of a layout pattern, and data which ends at the position where the storage declaration is terminated by data indicated by a row number 0090 corresponds to the description of a single layout pattern structure, and there are data items as many as the storage number. Layout pattern data “pattern” has data of an identification number id, as an attribute, and is discriminated from different layout pattern data. The identification number corresponds to a node number which will be described later in FIGS. 5 and 6. That is to say, layout pattern data indicated by an identification number 1 denotes layout pattern data indicated by reference number 1 shown in FIG. 5A. Element data “parent” indicated by a row number 0060 stores data of a reference pattern used to generate the above-described layout pattern, as identification number data. According to FIG. 17, data of a specifically prepared identifier “root” is stored in place of the identification number data. The identifier “root” is a basic pattern which is the source of each layout pattern. According to the layout pattern data “root”, the aspect-ratio size of an area is determined based on the rectangular shape of content data applied to the above-described layout pattern data “root”, as described above with reference to FIG. 4. Although the layout pattern data “pattern” has element data “rule” indicating an adjacent connection direction which will be described later, the layout pattern data “root” is provided with no element data “rule”.

FIG. 18 shows the layout pattern data 1 shown in FIG. 5A and an exemplary configuration of layout pattern data 1.1 shown in FIG. 5B. In addition to the layout pattern data 1 illustrated in FIG. 17, data within row numbers 0100 and 0170 indicates the configuration of the layout pattern data 1.1. A reference pattern identification number 1 indicated by a row number 0120 means that the concerned layout pattern data is connected to pattern data having the pattern identification number 1, which means that the id attribute of the element data “pattern” of the above-described pattern data is 1. Element data “rule” indicated by a row number 0140 indicates the direction of adjacent connection to pattern data shown in the element data “parent”, and has data “top”, data “right”, data “bottom”, and data “left” as values. Data “right” indicated by a row number 0150 means that the concerned layout pattern data is connected to new layout pattern data generated based on the length of the right side of a rectangle expressed by pattern data “parent”.

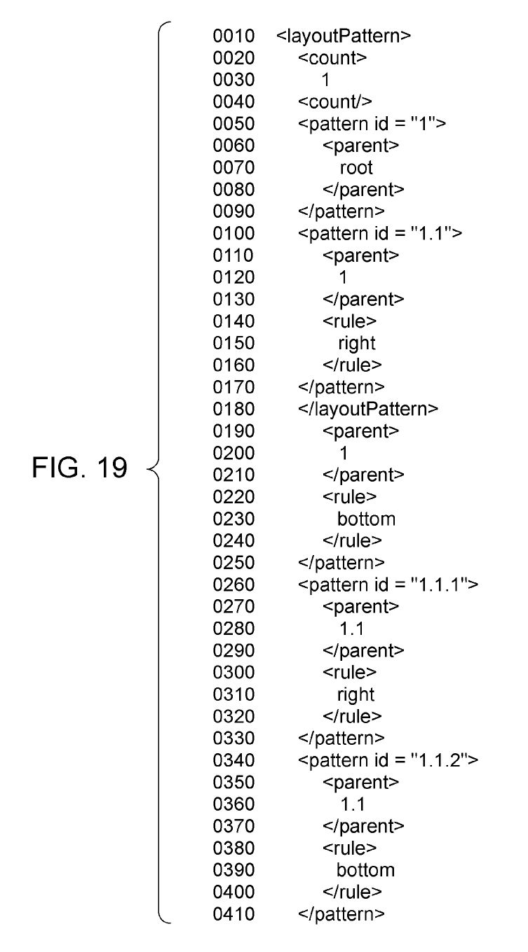

FIG. 19 shows the configuration of each of four layout pattern data items 1, 1.1, 1.1.1, and 1.1.2 that are shown in FIGS. 5A, 5B, and 5C. For example, the layout pattern data 1.1.2 indicated by row numbers 0340, 0350, 0360, 0370, 0380, 0390, 0400, and 0410 is connected to new pattern data in accordance with the lower side of reference pattern data 1.1. A search for data “pattern” having an id attribute 1.1 is made to obtain the reference pattern data 1.1 which is referred to. Consequently, the pattern data described in FIG. 18 can be obtained.

Each of FIGS. 5A, 5B, 5C, and 5D shows an exemplary dynamic configuration including a layout pattern data item and/or a combination of layout pattern data items.

The layout pattern data (1) shown in FIG. 4 is equivalent to the layout pattern data 1 shown in FIG. 5A. The layout pattern data 1 includes a single area. New pattern data is generated by placing an area in juxtaposition with the single area in a horizontal direction and/or a vertical direction. When generating the new pattern data, layout pattern data provided as the generation source and a generation direction are specified. If the generation direction is the horizontal direction, basic pattern data 1 is additionally placed at the right and/or the left of the generation source pattern data so that the layout pattern data 1.1 is generated. If the generation direction is the vertical direction, the basic pattern data 1 is additionally placed under and/or on the generation source pattern data so that the layout pattern data 1.2 is generated.

If the pattern generation is continued, the layout pattern data 1.1 is generated as the generation source pattern data. When the generation direction is the horizontal direction, the layout pattern data 1.1.1 is generated. Further, when the generation source pattern data is determined to be the layout pattern data 1.1 and the generation direction is the vertical direction, the layout pattern data 1.1.2 and layout pattern data 1.1.3 are generated. If pattern data items that are orderly generated in the above-described manner overlap each other, that is to say, if the basic pattern data 1 is additionally placed on the left of layout pattern data 1.2.2 so as to obtain another pattern data item, and on the right of layout pattern data 1.2.3 so as to obtain still another pattern data item, both the obtained pattern data items become layout pattern data 1.2.2.2. Therefore, overlapping layout pattern data items are eliminated.

Identification numbers are allocated to the generated layout pattern data items for individual identification, and the generated layout pattern data items are included and managed in a tree-like structure shown in FIG. 6. In FIG. 6, the generated layout pattern data items that are indicated by the identification numbers correspond to nodes of the tree-like structure, and the nodes are linked up with one another. An identification number shown on the left of a link denotes the generation source, and that shown on the right of the link denotes pattern data for generation.

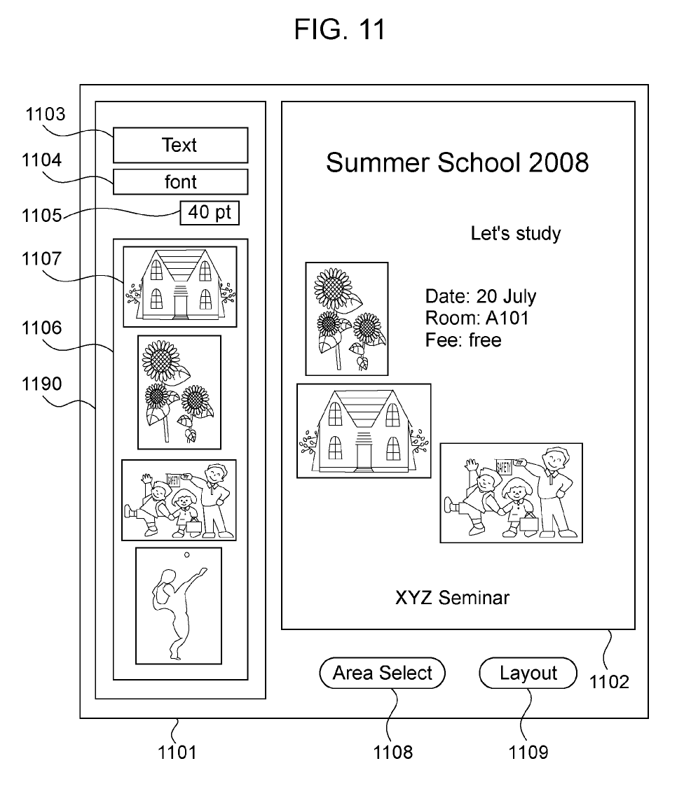

Each of FIGS. 11, 20, and 21 exemplarily shows how layout data is automatically generated on demand in the information processing apparatus of the above-described embodiment.

FIG. 11 shows layout editing operations performed to arrange content data including text data, image data, and so forth on page data based on operations performed by the user. An operation display frame 1101 is provided to perform a layout editing operation. The operation display frame 1101 includes a page editing operation frame 1102, a content specification operation section 1190, an automatic-layout-area-specification operation button 1108, and an automatic-layout-operation specification button 1109.

When a text-frame-insertion specification section 1103 provided to insert a text frame, which is provided in the content specification operation section 1190, is dragged into the page editing operation frame 1102 by using a pointing device 15, a text frame is generated in the page editing operation frame 1102. Then, keystroke information transmitted from a keyboard 14 is shown in the text frame, as text code data. The shown text code data can be changed through operations performed in a font specification section 1104 and a font-size specification section 1105. An image insertion specification section 1106 is provided to display image information items that are stored in the external storage 16, in list form, as reduced image information items such as image information 1107. If the image insertion specification section 1106 is dragged into the page editing operation frame 1102 by using the pointing device 15, an image frame is generated in the page editing operation frame 1102.

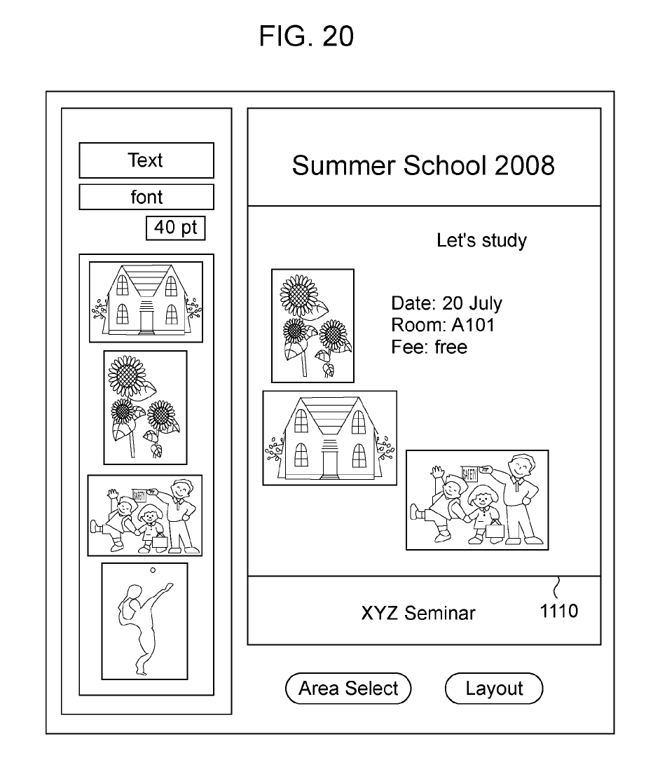

FIG. 20 shows a state attained by pressing the automatic-layout-area-specification operation button 1108 in the editing state shown in FIG. 11 so that area specification mode is selected and an automatic layout target area is specified by using the pointing device 15. An area 1111 specified as the automatic layout target area is highlighted.

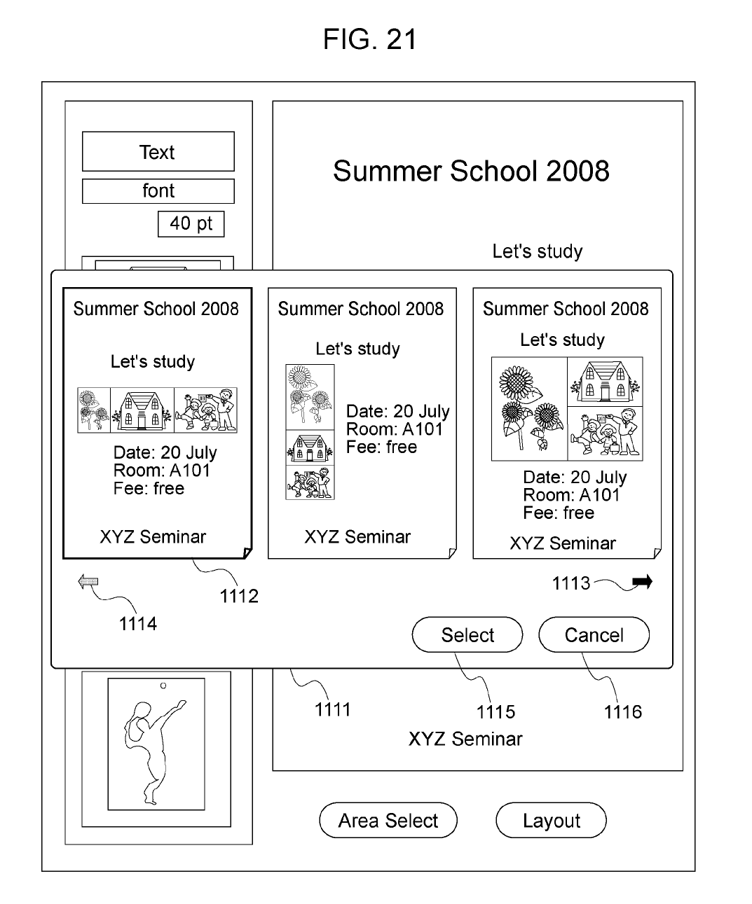

FIG. 21 shows the state where at least two results of automatically laying out content data items shown in the specified area are displayed in list form by pressing the automatic-layout-operation specification button 1109 in the state where the area specification has already been done. In a layout result display frame 1111 shown in FIG. 21, a selected layout candidate 1112 is highlighted. The selected layout candidate may be changed to the next candidate and/or the previous candidate by performing an operation by using the keyboard and/or the pointing device. A display icon 1113 indicates that there is the next candidate, and a display icon 1114 indicates that there is the previous candidate. If the display icons 1113 and 1114 are grayed out, there is no candidate. A candidate determining button 1115 is provided to insert data of the selected layout candidate in the page-editing-operation frame 1120 so that automatic layout processing is terminated. A cancellation button 1116 is provided to instruct to stop operations of the automatic layout processing so that the state is returned to the state where an area specification operation instruction is not yet issued, as shown in FIG. 11.

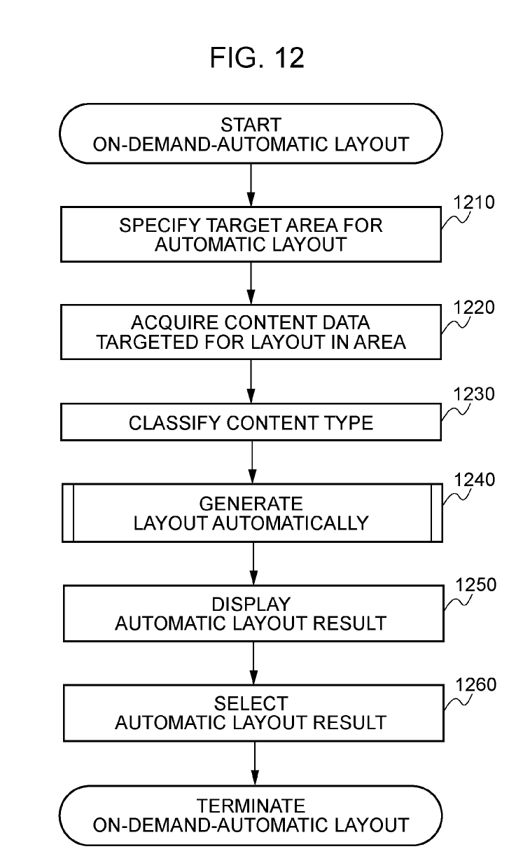

FIG. 12 is a flowchart showing exemplary automatic-layout processing procedures performed when on-demand automatic layout operations shown in FIG. 11 are performed. Here, a program relating to the above-described flowchart is stored in the external storage 16, read out to the RAM 13, and executed by the CPU 11.

At step 1210, an operator presses the automatic-layout-area-specification operation button 1108 shown in FIG. 11 so that the area specification mode is selected, and the operator specifies the automatic layout target area by using the pointing device 15.

At step 1220, the content input unit 201 acquires content data targeted to be laid out, such as text data, image data, and so forth that are shown in the specified area shown in FIG. 20.

At step 1230, the content data acquired at step 1220 is classified based on the type thereof. That is to say, the classification is performed based on whether the content data is the text data or the image data.

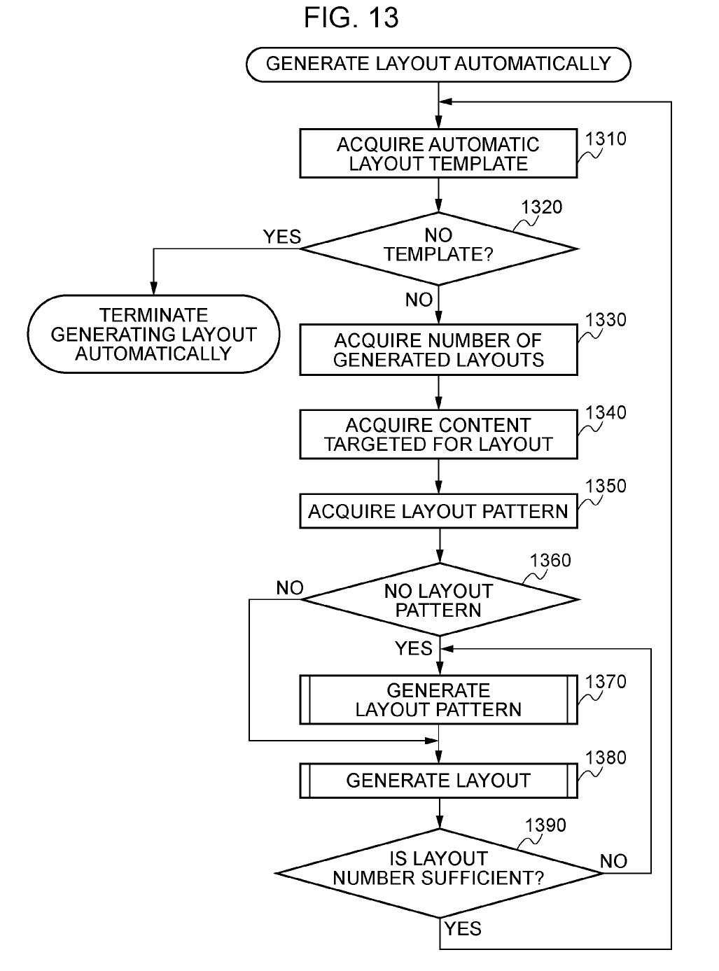

At step 1240, the content data acquired at step 1220 is automatically laid out. Details on processing performed at step 1240 will be described with reference to FIG. 13 that will be described later.

Next, at step 1250, automatic layout results are shown in the display frame 1112 in groups of a predetermined number.

The order in which the automatic layout results are displayed may be determined based on the score of the automatic layout pattern data. Further, the similarity between the automatic layout pattern data and layout data that had been determined at the layout area specification time is calculated, and the automatic layout results may be displayed in the order corresponding to the inverse ranks of the score. Namely, the automatic layout results may be displayed in decreasing order of dissimilarity so that a layout result which is not expected by the operator is shown preferentially.

At step 1260, a layout result selected by the operator is incorporated in the page editing area and the processing procedures are finished.

FIG. 13 is a flowchart showing exemplary automatic layout generation processing procedures. Here, a program relating to the above-described flowchart is stored in the external storage 16, read out to the RAM 13, and executed by the CPU 11.

At step 1310, the layout generation unit 202 acquires document template data stored in the template holding unit 204.

At step 1320, it is determined whether or not the document template data is acquired. If no template data is acquired, the automatic layout generation processing procedures are terminated. If it is determined that the template data is acquired, the processing advances to step 1330.

At step 1330, data of the number of generated layout data items is acquired. The generated layout number is acquired by reading the number of different pattern data items of recommended layout pattern data shown in the above-described image frame 313 in the document template data shown in FIG. 3. Since data “5” is read as a variation parameter in the image frame 313, the value of the generated layout number becomes five.

Next, content data targeted to be laid out is acquired at step 1340. Of the content data items acquired at step 1220 which is described above, content data discriminated from image data at step 1230 is acquired as the content data targeted to be laid out. According to the exemplary area specification illustrated in FIG. 20, three image data items 701, 702, and 703 that are shown in FIG. 7 are acquired.

Next, at step 1350, the layout generation unit 202 acquires layout pattern data stored in the layout pattern holding unit 205. The layout generation unit 202 stores, in advance, only a single layout pattern data item (1) shown in FIG. 4 described above.

It is determined whether or not there is layout pattern data at step 1360. If there is no layout pattern data, the processing advances to step 1370. If the layout pattern data is acquired, the processing advances to step 1380.

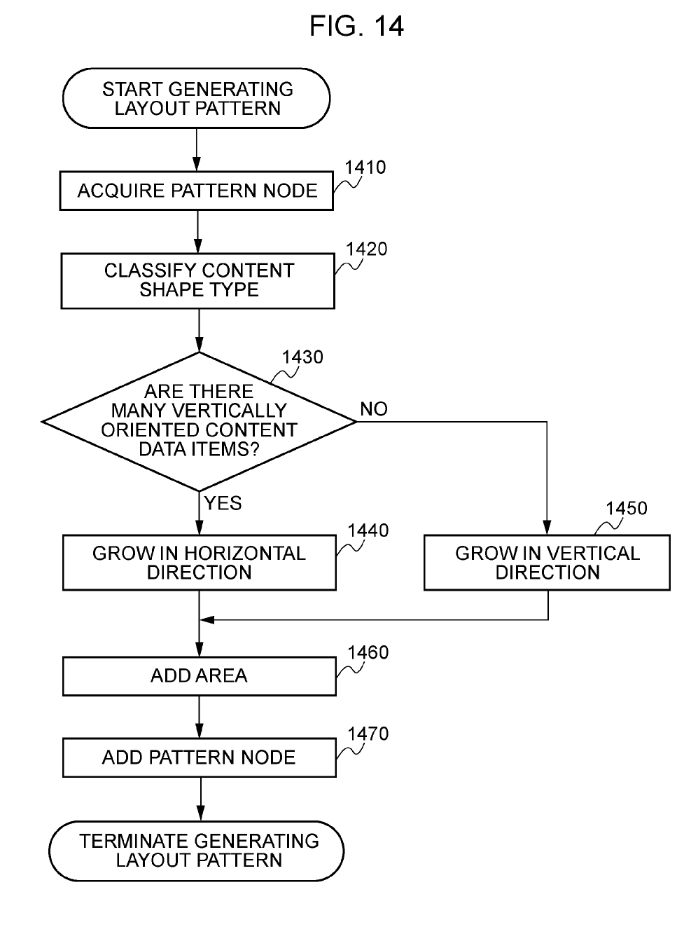

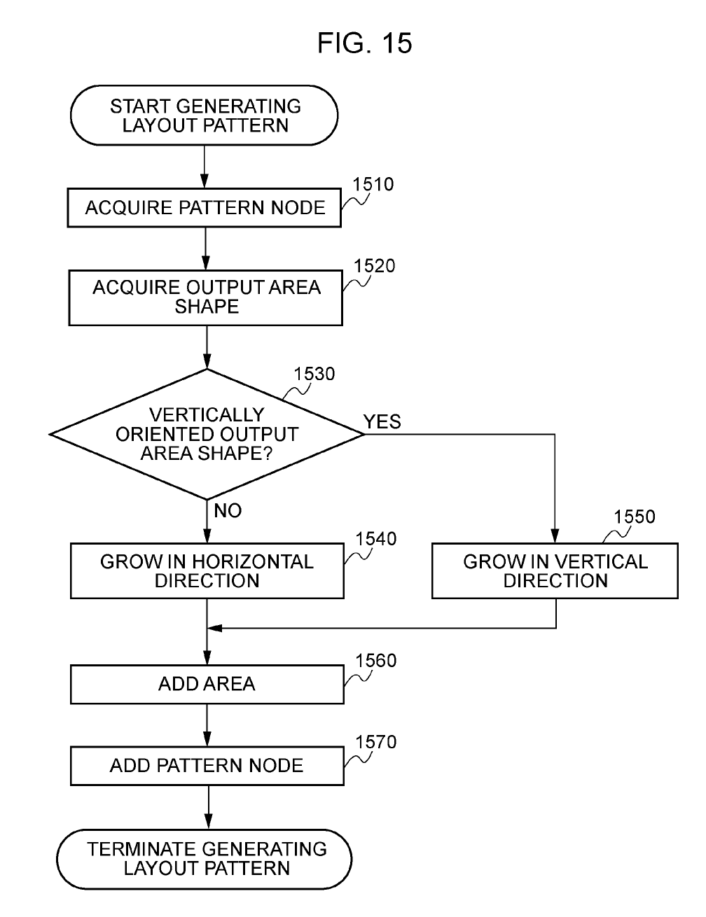

New layout pattern data is generated at step 1370. Details of layout pattern generation processing 1370 will be described with reference to FIGS. 14 and 15 that will be described later.

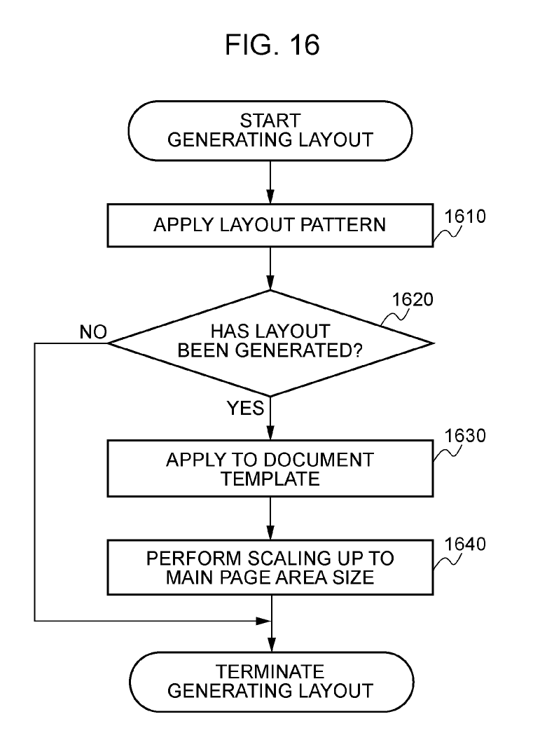

Layout data is generated by applying the content data acquired at step 1340 to the layout pattern data acquired at step 1380. The details of the layout generation processing 1380 will be described with reference to FIG. 16 that will be described later.

At step 1390, the number of generated layout data items acquired at step 1330 is compared to the value of a layout number counter so as to determine whether or not the generated layout data number is attained. If the generated layout number is attained, the processing loops to step 1310. Otherwise, the processing loops to step 1370.

FIG. 16 is a flowchart showing exemplary layout generation processing procedures. Here, a program relating to the above-described flowchart is stored in the external storage 16, read out to the RAM 13, and executed by the CPU 11.

At step 1610, data of a layout configuration including a combination of content data items is generated by applying content data targeted to be laid out to layout pattern data. The layout configuration is not successfully generated if the number of areas included in the layout pattern data does not agree with that of content data items targeted to be laid out.

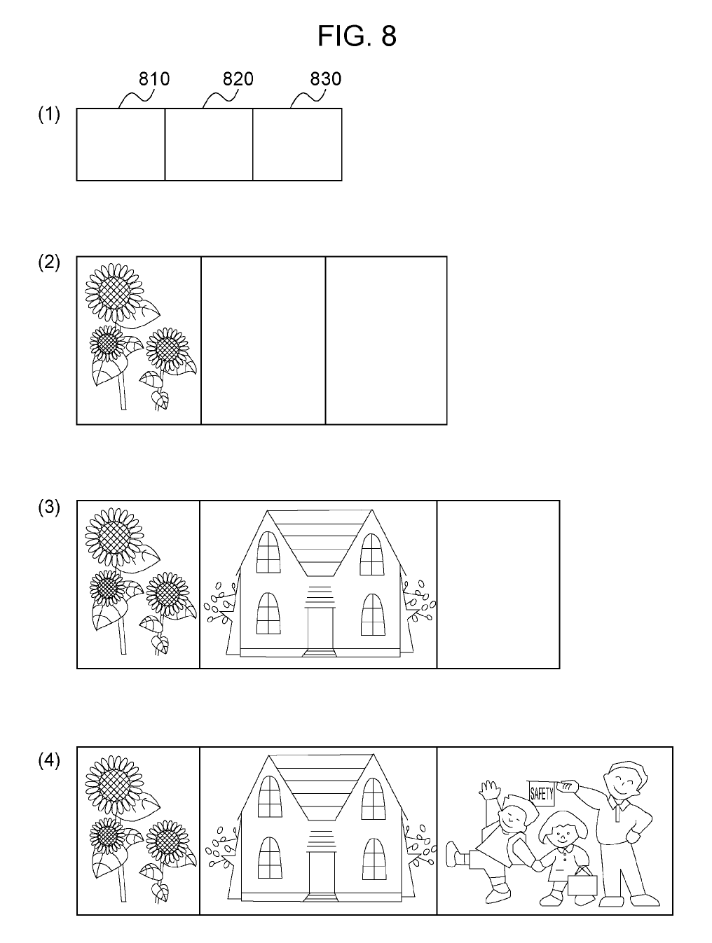

If the number of the areas included in the layout pattern data agrees with that of the content data items, the three image data items 701, 702, and 703 that are shown in FIG. 7 are applied to layout pattern data (1) shown in FIG. 8, for example, so that a content-combination layout structure is generated.

Next, image data 701 is applied to the leftmost area 810, as is the case with layout pattern data (2) shown in FIG. 8, so that the aspect ratio of image data 701, which is indicated by a height H1 and a width W1, is retained. Consequently, the shape of area data 810 is determined so that the area 810 has the height H1 and the width W1. Each of areas 820 and 830 that are connected to the area 810 has the same height as that of the area 810, and a width having an arbitrary initial value. Next, when the image data 702 is applied to the area 820 of layout pattern data (3) shown in FIG. 8, the image data 702 has the height H1 and a width of W2*(H1/H2) so that the width and the height of the area 820 are determined.

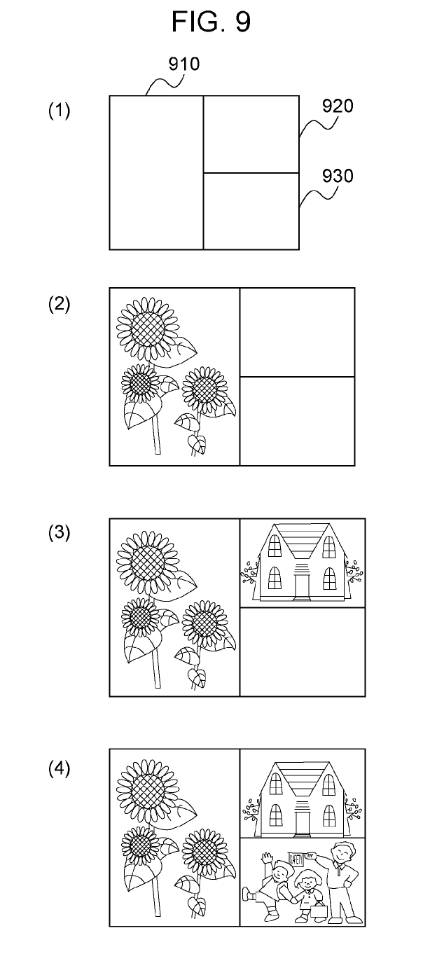

When the image data 703 is applied to the area 830 of the layout pattern data (3) shown in FIG. 8, the image data 703 has the height H1 and a width of W3*(H1/H3) so that the width and the height of the area 830 are determined. Further, if three images that are equivalent to one another are applied to layout pattern data (1) shown in FIG. 9, first, the image data 701 is applied to an area 910, as is the case with layout pattern data (2) shown in FIG. 9, and the aspect ratio of the image data 701, which is indicated by the height H1 and the width W1, is retained. Subsequently, the shape of the area 910 is determined so that the area 910 has the height H1 and the width W1. The height of each of areas 920 and 930 that are connected to the area 910 is proportionally determined so that the total of the height of the area 920 and that of the area 930 becomes the same as the height of the area 910. Namely, the height of the area 920 is determined to be H1*(H2/(H2+H3)), and that of the area 930 is determined to be H1*(H3/(H2+H3)), and the width of each of the areas 920 and 930 has an arbitrary initial value.

Next, when the image data 702 is applied to the area 920 of the layout pattern data (3) shown in FIG. 9, the image data 702 has a height H1*(H2/(H2+H3)) and a width W2*(H1/(H2+H3)) so that the width and the height of the area 920 are determined. When the image data 703 is applied to the area 930 of the layout pattern data (3) shown in FIG. 9, the image data 703 has a height H1*(H3/(H2+H3)) and a width W3*(H1/(H2+H3)), as in a manner similar to the above-described case, so that the width and the height of the area 930 are determined.

At step 1620, it is determined whether or not a layout structure is generated. If the layout structure is not successfully generated, the processing procedures are terminated. Otherwise, the processing advances to step 1630.

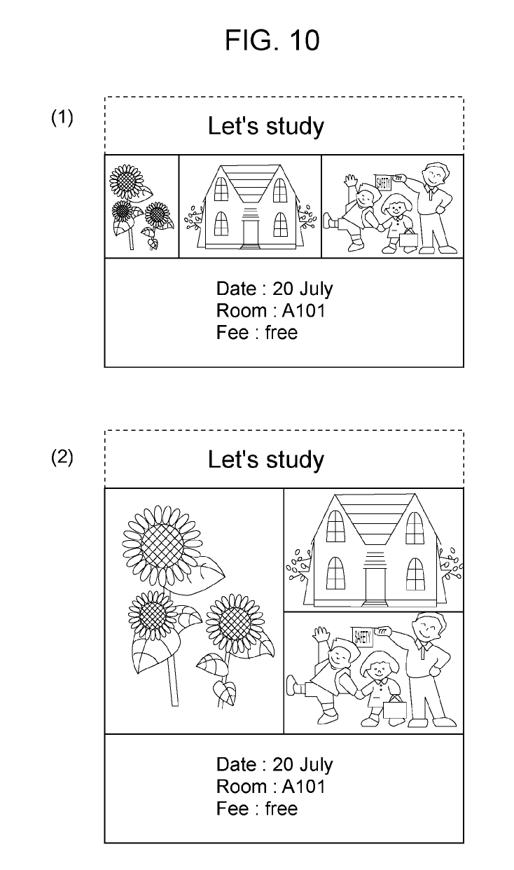

At step 1630, the layout structure of the content data, which is generated at step 1610, is inserted into the image frame of document template data, and the text data transmitted at step 1220 shown in FIG. 12 is inserted into the text frame. If the layout pattern data (3) shown in FIG. 8, which is an example of the layout structure generated at step 1610, is applied to the box T31 of the document template data shown in FIG. 3, layout data (1) shown in FIG. 10 is obtained. If the layout structure of layout pattern data (3) shown in FIG. 9 is applied to the box T31, layout data (2) shown in FIG. 10 is obtained.

At step 1640, layout data completed by inserting data into each of content arrangement frames of the document template data at step 1630 is scaled based on the actual width of the area specified at step 1210 shown in FIG. 12 while retaining the aspect ratio of the layout data. Consequently, the layout data is completed. Then, the value of the layout number counter (not shown) is counted up and the processing procedures are terminated.

FIG. 14 is a flowchart showing exemplary layout pattern generation processing procedures. A program relating to the above-described flowchart is stored in the external storage 16, read out to the RAM 13, and executed by the CPU 11.

At step 1410, data of a node number which becomes the generation source is acquired from the management tree of the layout pattern data, which is shown in FIG. 6.

At step 1420, the aspect-ratio shapes of content data items targeted to be laid out are classified.

At step 1430, it is determined whether or not the proportion of content data items determined to be vertically oriented based on their aspect ratios is 50% or more. In that case, the value of the ratio H/W of each of the content data items is one or more, where the vertical direction size is determined to be H and the horizontal direction size is determined to be W. If there are many vertically-oriented content data items, a layout-pattern generation direction is determined to be a vertical direction at step 1450. Otherwise, the layout-pattern generation direction is determined to be a horizontal direction at step 1440.

At step 1460, layout pattern data is generated through the area addition described in detail with reference to FIG. 5 based on the node number which becomes the pattern generation source and in the generation direction determined at step 1440 and/or step 1450. Then, the generated layout pattern data is added to the pattern node tree at step 1470 and the processing procedures are terminated.

FIG. 15 is a flowchart showing different exemplary layout pattern generation processing procedures. Here, a program relating to the above-described flowchart is stored in the external storage 16, read out to the RAM 13, and executed by the CPU 11.

At step 1510, data of a node number which becomes the generation source is acquired from the management tree of the layout pattern data, which is shown in FIG. 6.

At step S1520, data of the shape of a layout output area is acquired. The layout output area is determined based on the shape of an image frame shown in document template data targeted to be laid out.

At step 1530, it is determined whether or not the layout output area is vertically oriented based on the aspect-ratio shape of the layout output area. That is to say, it is determined whether or not the value of the ratio H/W of the layout output area is larger than one, where the vertical-direction size is determined to be H and the horizontal-direction size is determined to be W. If it is determined that the layout output area has a vertically-oriented shape, the layout-pattern generation direction is determined to be a vertical direction at step 1550. Otherwise, the layout-pattern generation direction is determined to be a horizontal direction at step 1540.

At step 1560, layout pattern data is generated through the area addition described in detail with reference to FIG. 5 based on the node number which becomes the pattern generation source and in the generation direction determined at step 1540 and/or step 1550. Then, the generated layout pattern data is added to the pattern node tree at step 1570 and the processing procedures are terminated.

Thus, the above-described embodiment allows for outputting at least two different layout pattern data items even though many layout pattern data items are not stored in advance and the operator does not specify the arrangement position.

### Other Embodiments

It is to be understood that the object of the present invention is achieved by supplying a storage medium (and/or a recording medium) storing program code of software for implementing the functions of the above-described embodiments to a system and/or an apparatus so that a central processing unit (CPU) and/or a microprocessing unit (MPU) of the system and/or the apparatus reads and executes the program code stored in the storage medium. In that case, the program code itself read from the storage medium implements the functions of the above-described embodiments, and the storage medium storing the program code constitutes another embodiment of the present invention.

Further, the central processing unit of the system and/or the apparatus executes the read program code so that an operating system (OS) or the like running on the system and/or the apparatus executes part of and/or the entire actual processing based on instructions of the program code. The functions of the above-described embodiments are achieved through the actual processing, which constitutes another embodiment of the present invention.

Further, the program code read from the storage medium may be written into a memory of a function expansion card inserted into the system and/or the apparatus, or a function expansion unit connected to the system and/or the apparatus. After that, a CPU or the like provided in the function expansion card and/or the function expansion unit may execute part of and/or the entire actual processing based on instructions of the program code so that the functions of the above-described embodiments are implemented, which constitutes another embodiment of the present invention.

When applying the present invention to the above-described storage medium, the storage medium (computer readable storage medium) stores the program code corresponding to the above-described flowcharts.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-239442 filed on Sep. 18, 2008, which is hereby incorporated by reference herein in its entirety.

What is claimed is:

1. An information processing apparatus comprising:
a layout unit configured to generate at least one layout data item based on a layout pattern data item in which information about an area where at least one content data item is arranged is defined; and
a generation unit configured to generate at least one new layout pattern data item based on the layout pattern data item when a number of at least two different layout data items generated by the layout unit is smaller than a predetermined number.

2. The information processing apparatus according to claim 1, wherein the layout pattern generation unit generates a combination of the layout pattern data items based on at least one of a shape determined based on an aspect ratio of the content data item and a shape determined based on an aspect ratio of a layout output area.

3. The information processing apparatus according to claim 1, wherein the generation unit classifies shapes of the content data items, adds an arrangement area in a horizontal direction if there are many vertically oriented shapes, and adds the arrangement area in a vertical direction if there are not many vertically oriented shapes so that layout pattern data is generated.

4. The information processing apparatus according to claim 1, wherein the generation unit classifies a shape of an output area, adds an arrangement area in a vertical direction if the output area is vertically oriented, and adds the arrangement area in a horizontal direction if the output area is not vertically oriented so that layout pattern data is generated.

5. The information processing apparatus according to claim 1, further comprising:
a display unit configured to display at least two layout results generated based on the layout pattern data item generated by the generation unit; and
a selection unit configured to select at least one layout data item from among the displayed layout results.

6. An information processing method comprising the steps of:
generating at least one layout data item based on a layout pattern data item in which information about an area where at least one content data item is arranged is defined; and
generating at least one new layout pattern data item based on the layout pattern data item when a number of at least two different layout data items generated at the layout step is smaller than a predetermined number.

7. The information processing method according to claim 6, wherein, at the layout pattern generation step, a combination of the layout pattern data items is generated based on at least one of a shape determined based on an aspect ratio of the content data item and a shape determined based on an aspect ratio of a layout output area.

8. The information processing method according to claim 6, wherein, at the generation step, shapes of the content data items are classified, an arrangement area is added in a horizontal direction if there are many vertically oriented shapes, and the arrangement area is added in a vertical direction if there are not many vertically oriented shapes so that layout pattern data is generated.

9. The information processing method according to claim 6, wherein, at the generation step, a shape of an output area is classified, an arrangement area is added in a vertical direction if the output area is vertically oriented, and the arrangement area is added in a horizontal direction if the output area is not vertically oriented so that layout pattern data is generated.

10. The information processing method according to claim 6, further comprising the steps of:
displaying at least two layout results generated based on the layout pattern data item generated at the generation step; and
selecting at least one layout data item from among the displayed layout results.

11. A storage medium storing a program making a computer execute the steps of:
generating at least one layout data item based on a layout pattern data item in which information about an area where at least one content data item is arranged is defined; and
generating at least one new layout pattern data item based on the layout pattern data item when a number of at least two different layout data items generated at the layout step is smaller than a predetermined number.

12. The storage medium according to claim 11, wherein, at the layout pattern generation step, a combination of the layout pattern data items is generated based on at least one of a shape determined based on an aspect ratio of the content data item and a shape determined based on an aspect ratio of a layout output area.

13. The storage medium according to claim 11, wherein, at the generation step, shapes of the content data items are classified, an arrangement area is added in a horizontal direction if there are many vertically oriented shapes, and the arrangement area is added in a vertical direction if there are not many vertically oriented shapes so that layout pattern data is generated.

14. The storage medium according to claim 11, wherein, at the generation step, a shape of an output area is classified, an arrangement area is added in a vertical direction if the output area is vertically oriented, and the arrangement area is added in a horizontal direction if the output area is not vertically oriented so that layout pattern data is generated.

15. The storage medium according to claim 11, wherein the program further makes the computer execute the steps of:
displaying at least two layout results generated based on the layout pattern data item generated at the generation step; and
selecting at least one layout data item from among the displayed layout results.
